(19) United States
(12) Patent Application Publication
(10) Pub. No.: US 2021/0336988 A1
(43) Pub. Date: Oct. 28, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Tatsuo SUZUKI, Kanagawa (JP); Ye SUN, Kanagawa (JP)

(73) Assignee: FUJIFILM Business Innovation Corp., Tokyo (JP)

(21) Appl. No.: 17/102,445

(22) Filed: Nov. 24, 2020

(30) Foreign Application Priority Data
Apr. 27, 2020 (JP) 2020-077997

(51) Int. Cl. H04L 29/06; G06N 20/00; H04L 29/12; H04L 12/24

(52) U.S. Cl. CPC H04L 63/1466; H04L 41/16; H04L 61/2007; G06N 20/00

(57) ABSTRACT

An information processing apparatus includes a processor configured to input a new domain name, a new Internet protocol (IP) address, and information indicating a name server managing the new domain name to a learner to determine presence or absence of a threat of a new destination host indicated by the new domain name and the new IP address, wherein, by using learning data including a domain name and an IP address indicating a destination host, information indicating a name server managing the domain name, and information on presence or absence of a threat of the destination host, the learner has learned to output the information on the presence or the absence of the threat of the destination host indicated by the domain name and the IP address in response to an input of the domain name, the IP address, and the information indicating the name server managing the domain name.

### Cross-Reference to Related Applications

This application is based on and claims priority under 35 USC 119 from Japanese Patent Application No. 2020-077997 filed Apr. 27, 2020.

### BACKGROUND

### (i) Technical Field

The present disclosure relates to an information processing apparatus and a non-transitory computer readable medium.

### (ii) Related Art

Techniques of determining the presence or absence of a threat of a destination host in accessing the determination host from an originating terminal via a communication network, such as the Internet, have been disclosed. The presence of the threat means a host that may send unscrupulous software, such as malware, to the originating terminal or may adversely affect the originating terminal.

Japanese Patent No. 6196008 discloses an apparatus that calculates a threat level (malignancy) of a target communication destination. The apparatus extracts feature information on known communication destinations and the target communication destination in accordance with a temporal change in the presence or absence of the posting on a benign communication destination list and a malignant communication destination list of the known communication destinations and the target communication destination. The apparatus then computes the malignancy of the target communication destination in accordance with the feature information.

The apparatus of the related art determining the presence or absence of the threat of a destination host determines the presence or absence of the threat related to the destination host known to the apparatus. In other words, the apparatus of the related art determining the presence or absence determines the presence or absence of a destination host whose domain name or Internet protocol (IP) address is known to the apparatus. On the other hand, it is difficult for apparatuses of the related art to detect the presence or absence of a destination host unknown to the apparatuses of the related art.

### SUMMARY

Aspects of non-limiting embodiments of the present disclosure relate to detecting the presence or absence of a threat of an unknown destination post.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus includes a processor configured to input a new domain name, a new Internet protocol (IP) address, and information indicating a name server managing the new domain name to a learner to determine presence or absence of a threat of a new destination host indicated by the new domain name and the new IP address, wherein, by using learning data including a domain name and an IP address indicating a destination host, information indicating a name server managing the domain name, and information on presence or absence of a threat of the destination host, the learner has learned to output the information on the presence or the absence of the threat of the destination host indicated by the domain name and the IP address in response to an input of the domain name, the IP address, and the information indicating the name server managing the domain name.

### BRIEF DESCRIPTION OF THE DRAWINGS

Exemplary embodiment of the present disclosure will be described in detail based on the following figures, wherein:

FIG. 1 illustrates a configuration of a network system of the exemplary embodiment;

FIG. 2 illustrates a configuration of a security server of the exemplary embodiment; and

FIG. 3 illustrates a concept of a learning process of a learner.

### DETAILED DESCRIPTION

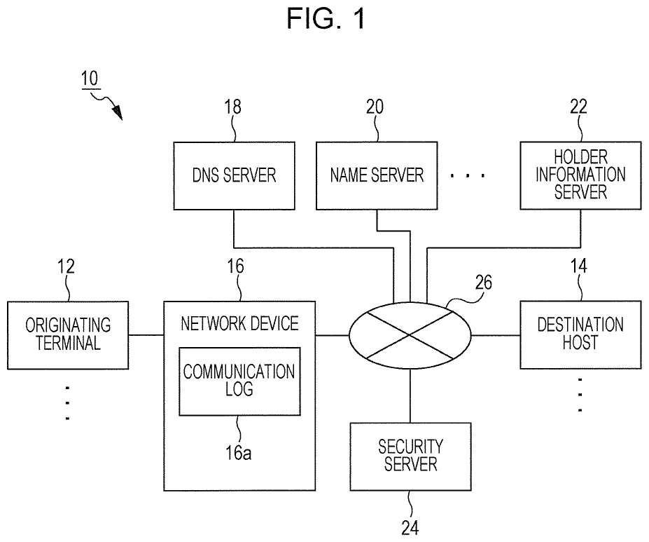

FIG. 1 illustrates a configuration of a network system 10 of an exemplary embodiment of the disclosure. The network system 10 includes one or more originating terminals 12, multiple destination hosts 14, network device 16, domain name system (DNS) server 18, and multiple name servers 20, holder information server 22, and security server 24. The security server 24 is an example of an information processing apparatus of the exemplary embodiment of the disclosure. The originating terminal 12 and network device 16 are communicably connected to each other via a local area network (LAN), such as an Intranet. The destination host 14, network device 16, DNS server 18, name server 20, holder information server 22, and security server 24 are communicably connected to each other via a communication network 26 including the Internet and LAN.

The originating terminal 12 is, for example, a personal computer and is used by a user. The originating terminal 12 may also be a mobile terminal, such as a tablet terminal. The originating terminal 12 includes a communication interface, memory, display, input interface, and processor. The communication interface is used to communicate with the destination host 14 via the network device 16. The memory includes a hard disk and/or random-access memory (RAM). The display is a liquid-crystal display or the like. The input interface includes a mouse, keyboard, and/or touch panel. The processor includes a central processing unit (CPU) and a microcomputer.

The destination host 14 may be a server (such as a web server) and may provide a variety of data (such as webpage data) to a device accessing via the communication network 26. Using a virtual host, multiple destination hosts 14 may be virtually defined on a single server. There may be a threatening destination host 14 (such as the one sending malware) illegally affecting the originating terminal 12 from among multiple destination hosts 14. The destination hosts 14 may include destination hosts 14 that the originating terminal 12 has not accessed. Any of those that the originating terminal 12 has not accessed may be threatening the originating terminal 12.

The network device 16 is connected over a communication line between the originating terminal 12 and the destination host 14. The network device 16 performs a process assuring security when the originating terminal 12 communicates with the destination host 14 via the communication network 26. In other words, the network device 16 protects the originating terminal 12 from a threatening destination host 14. For example, the network device 16 examines data (for example, a packet) transmitted from the destination host 14. The network device 16 includes a firewall or an intrusion prevention system (IDS). If the network device 16 determines that the data is unauthorized, the network device 16 blocks the communication between the originating terminal 12 and the destination host 14 with the firewall or the IDS. The unauthorized data is data that adversely affects the originating terminal 12 or data has a possibility that adversely affects the originating terminal 12.

According to the exemplary embodiment, when the user specifies a uniform resource locator (URL) of the destination host 14 using the originating terminal 12, the network device 16 monitors the communication between the originating terminal 12 and the destination host 14 in accordance with the URL, and detects any possible unauthorized data from the destination host 14. The URL includes a scheme name (e.g., http://) representing a communication protocol (e.g., hypertext transfer protocol) and a domain name representing the destination host 14, such as fully qualified domain name (FQDN, such as www.fujixerox.co.jp). FQDN includes a character string. In the context of the specification, the characters include a numerical character.

According to the exemplary embodiment, the network device 16 is connected to the originating terminal 12 and performs the process assuring security when the originating terminal 12 communicates with the destination host 14 via the communication network 26.

When the user specifies the URL of the destination host 14 using the originating terminal 12, the originating terminal 12 transmits the URL to the network device 16. The network device 16 transmits the FQDN to the DNS server 18 to acquire the IP address (name resolution) of the destination host 14 in accordance with the FQDN included in the URL.

The DNS server 18 performs mutual conversion between the domain name and the IP address. The DNS server 18 performs a name resolution process for the FQDN received from the network device 16 and identifies the IP address of the destination host 14 indicated by the FQDN. According to the exemplary embodiment, the DNS server 18 is a full-service resolver and performs the name resolution process in cooperation with multiple name servers 20.

The name server 20 is an authoritative server and manages domain names within a specific range. For example, one name server 20 manages domain names “xxx.net” and another name server 20 manages domain names “xxx.org”. Specifically, the name server 20 has a zone file including information on a domain name within a range managed by the name server 20. By referring to the zone file, the name server 20 recognizes the range of the domain names managed by the name server 20.

The DNS server 18 transmits the FQDN received from the network device 16 to multiple name servers 20. A name server 20 managing the FQDN from among the name servers 20 having received the FQDN identifies the IP address corresponding to the FQDN by referring to the zone file of the name server 20. The name server 20 transmits the identified IP address to the DNS server 18. The DNS server 18 then transmits to the network device 16 the IP address received from the name server 20 (the IP address of the destination host 14) and the IP address of the name server 20 managing the FQDN (namely, having transmitted the IP address to the DNS server 18).

The DNS server 18 and at least some of the name servers 20 may be integrated into a unitary body. In such a case, the DNS server 18 manages the domain names within a given range, specifically, the DNS server 18 has the zone file including the information on the domain names within the given range.

The network device 16 having received from the DNS server 18 the IP address of the destination host 14 accesses the destination host 14 in accordance with the IP address. In other words, the network device 16 transmits a communication request or a transmission request for data to the destination host 14. The destination host 14 accessed by the network device 16 transmits to the network device 16 predetermined data (for example, web data) in response to the accessing.

Using the firewall or IPS, the network device 16 determines whether the data (such as a packet) received from the destination host 14 is unauthorized data. If the network device 16 determines that the data is not unauthorized, the network device 16 transmits the data to the originating terminal 12. The communication is thus authorized between the originating terminal 12 and the destination host 14. If the data is unauthorized, the network device 16 blocks the data, inhibits the communication between the originating terminal 12 and the destination host 14, and notifies the originating terminal 12 that the connection with the destination host 14 is inhibited.

The determination results are stored on the memory of the network device 16 as the communication log 16a. Regardless of whether the data from the destination host 14 is unauthorized, the determination results are accumulated as the communication log 16a each time the communication is performed between the originating terminal 12 and the destination host 14. The communication log 16a includes but is not limited to determination time (communication time), IP address of the originating terminal 12, FQDN and the IP address of the destination host 14, name (name server name) and IP address of the name server 20 managing the FQDN, and information on the presence or absence of a threat of the destination host 14 (presence or absence of the unauthorized data). These pieces of information are mutually linked. If the network device 16 determines that the data from the destination host 14 is unauthorized data, the communication log 16a responsive to the communication further includes a reason why the data is determined as the unauthorized data (for example, the detection of malware), and a name of a detected computer virus.

The holder information server 22 stores holder information indicating holders of the domain names or IP addresses of multiple destination hosts 14. By sending a desired domain name or IP address as a query to the holder information server 22, anybody may acquire the holder information on the holder of the domain name or IP address related to the query. The service provided by the holder information server 22 is called Whois.

The holder information server 22 stores not only the domain name or the IP address of the name of the holder as the holder information but also information indicating the holder country of the IP address and the network name of the IP address. The network name is an identifier uniquely identifying the IP address when a regional Internet registry (an organization managing the IP address) assigns an IP address to a holder. If a holder desires multiple IP addresses, the same network name is assigned to the IP addresses (note that the network name uniquely identifies only those IP addresses and is not used for other IP addresses).

The security server 24 includes a server computer. The security server 24 determines the presence or absence of a threat of the destination host 14 indicted by a URL specified by the originating terminal 12. The security server 24 in particular determines the presence or absence of a threat of a destination host 14 unknown to the originating terminal 12. The destination host 14 unknown to the originating terminal 12 is a destination host 14 that the originating terminal 12 has not accessed and that the network device 16 has not determined as to whether the data from that destination host 14 is unauthorized data.

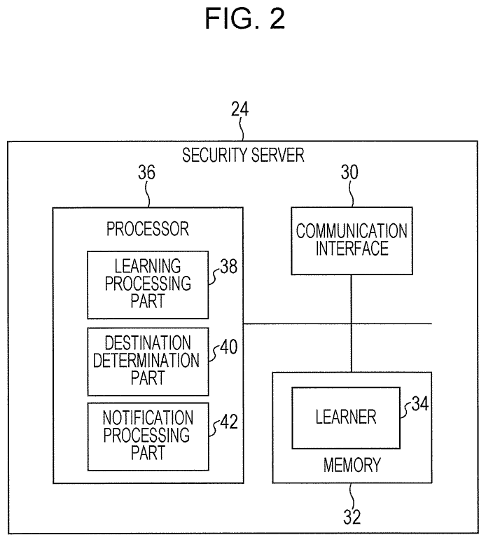

FIG. 2 illustrates a configuration of the security server 24. Referring to FIG. 2, the elements of the security server 24 are described.

The communication interface 30 includes, for example, a network adapter. The communication interface 30 exhibits the function of communication with another device (such as the network device 16) via the communication network 26.

The memory 32 includes a hard disk, solid-state drive (SSD), read-only memory (ROM), and/or random-access memory (RAM). The memory 32 may be external to a processor 36 described below or part of the memory 32 may be internal to the processor 36. The memory 32 stores an information processing program that operates each element of the security server 24. Referring to FIG. 2, the memory 32 stores a learner 34.

The learner 34 is configured to be a recurrent neural network (RNN) model. The learner 34 is described in detail below together with a process of a learning processing part 38. The learner 34 is actually a computer program defining the structure of the learner 34 and a process execution program that processes a variety of parameters related to the learner 34 and data input to the learner 34. The storage of the learner 34 on the memory 32 is intended to mean that the programs and the parameters are stored on the memory 32.

The processor 36 refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). The processor 36 is broad enough to encompass one processor or plural processors in collaboration which are located physically apart from each other but may work cooperatively. Referring to FIG. 2, the processor 36 performs the functions of the learning processing part 38, destination determination part 40, and notification processing part 42 in accordance with an information processing program stored on the memory 32.

The learning processing part 38 performs a learning process. In the learning process, the learning processing part 38 causes the learner 34 to learn using, as learning data, data based on the communication log 16a received from the network device 16. Specifically, the learning processing part 38 causes the learner 34 to perform the learning process using, at least, a domain name (FQDN in the exemplary embodiment) indicating a destination host 14 (accessed by the originating terminal 12 in the past) and information on the presence or absence of a threat of the destination host 14.

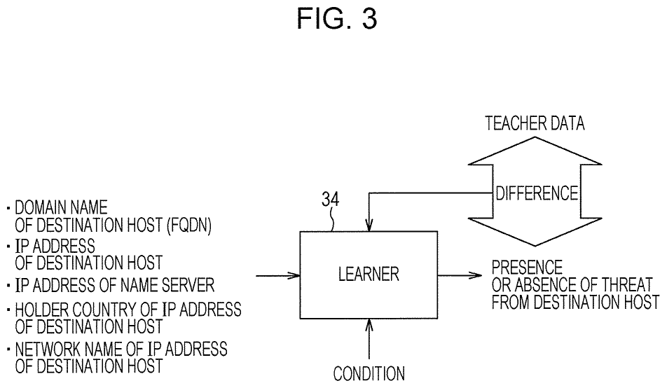

FIG. 3 illustrates the concept of the learning process of the learner 34 performed by the learning processing part 38 of the exemplary embodiment. The learning processing part 38 uses as the learning data the domain name and IP address indicating the destination host 14, information indicating the name server 20 managing the domain name, and the information on the presence or absence of the threat of the destination host 14. Specifically, the learning processing part 38 inputs to the learner 34 the FQDN and the IP address indicating the destination host 14 and the information indicating the name server 20 managing the FQDN, causes the learner 34 to output the prediction of the presence or absence of the threat of the destination host 14, and causes the learner 34 to learn in accordance with a difference between the output prediction of the presence or absence of the threat of the destination host 14 and the information (results) on the presence or absence of the threat of the destination host 14 serving as teacher data.

The learning processing part 38 repeats the learning process and the learner 34 may thus more accurately output the information on the presence or absence of the threat of the destination host 14 while receiving the domain name and the IP address indicating the destination host 14 and the information indicating the name server 20 managing the domain name.

When the learner 34 is caused to learn to output the information on the presence or absence of the threat of the destination host 14, only the IP address of the destination host 14 may be used as the learning data. However, It is difficult to identify the destination host 14 with the IP address alone. This is particularly true in a name-based virtual host where a single IP address is assigned with multiple IP addresses. Given the same IP address, a change of holders may lead to a change in the information on the presence or absence of the threat of the destination host 14. For these reasons, the learning processing part 38 includes in the learning data the domain name of the destination host 14 as the information identifying the destination host 14.

A destination host 14 may possibly attempt to try an unauthorized access to the originating terminal 12 using domain generation algorithm (DGA). DGA is an algorithm that automatically creates a domain name. A threatening destination host 14 may be able to modify its own domain name using DGA each time the threatening destination host 14 attempts to try an unauthorized access. According to the exemplary embodiment, the learner 34 may learn using a large amount of learning data (including the domain names of the destination hosts 14) in accordance with the accumulated communication log 16a. In other words, the learner 34 may learn using a large amount of learning data including a variety of domain names created by DGA. In the learning process, the learner 34 may learn the feature of automatic creation of the domain names by DGA (in other words, the feature of the domain names automatically created by DGA). The learner 34 having learned may thus determine whether or not an input domain name is created by DGA. In this way, the learner 34 having learned the learning data may be able to output the information on the presence or absence of the threat of the destination host 14, also based on whether the input domain name is created by DGA.

According to the exemplary embodiment, the information used to identify the destination host 14 included in the learning data is the IP address of the destination host 14 as well. For example, if a threatening destination host 14 uses the DGA, the domain name of the destination host 14 is changed. If the IP address remains unchanged, the learner 34 may learn by identifying the threatening destination host 14 by the IP address. Specifically, by including the IP address of the destination host 14 in the learning data, the learner 34 may learn by appropriately identifying the destination host 14 even when the domain name is spoofed by the DGA.

If the destination host 14 is a name-based virtual host, a single IP address is assigned with multiple destination hosts 14. However, the destination host 14 may be uniquely identified by combining the IP address of the destination host 14 with the information indicating the name server 20 managing the domain name of the destination host 14. Since the multiple destination hosts 14 assigned to the same IP address (the name-based virtual host) have different domain names, the name servers 20 managing the domain name of each destination host 14 are typically different. The destination host 14 is thus uniquely identified by combining the IP address of the destination host 14 with the information indicating the name server 20 managing the domain name of the destination host 14.

There are times when multiple IP addresses are assigned to a single name server 20. According to the exemplary embodiment, in order to increase the variations of the learning data, the IP address of the name server 20 is used as information indicating the name server. If the variations of the learning data are sufficient, the name server name may be used as information indicating the name server 20.

A destination host 14 indicated by an IP address closer to the IP address of a threatening destination host 14 may frequently give a threat. In particular, a destination host 14 belonging to the same network as a threatening destination host 14 typically gives a threat. In such a case, a portion indicating the network of the IP address of the destination host 14 (the network address in IPv4) is the same and only a portion indicating the host (a host address in IPv4) is different as described in “xxx.yyy.zzz.0” and “xxx.yyy.zzz.1.” The learner 34 may predict the presence or absence of the threat of the input IP address with respect to the IP address of a threatening destination host 14. Specifically, the learner 34 may predict a higher possibility that a destination host 14 indicated by an IP address closer to the IP address of a threatening destination host 14 gives a threat. Concerning the domain name of the destination host 14, a difference of one character in the domain name may possibly indicate an unrelated destination host 14, and the prediction of the threat of that destination host 14 is difficult.

The use of the domain name of the destination host 14 as the information identifying the destination host 14 and the use of the IP address of the destination host 14 as the information identifying the destination host 14 have their advantages and disadvantages in the learning process of the learner 34. According to the exemplary embodiment, both the domain name of the destination host 14 and the IP address of the destination host 14 are used as the information identifying the destination host 14. This may address increasing the learning efficiency of the learning process and the prediction accuracy of the learned learner 34.

The learning processing part 38 may cause the learner 34 to learn using the learning data including information indicating the holder country of the IP address of the destination host 14. Specifically, the learning processing part 38 acquires information on the holder country of the IP address of the destination host 14 by transmitting to the holder information server 22 the FQDN of the destination host 14 included in the communication log 16a as a query and then includes the information indicating the holder country in the learning data. If the number of threatening destination hosts 14 is different from holder counter to holder country of the IP addresses of the destination hosts 14, the learner 34 may predict the presence or absence of the threat of the destination host 14 in accordance with the holder country of the IP address of the destination host 14.

The learning processing part 38 may further cause the learner 34 to learn using the learning data including the network name of the IP address of the destination host 14. Specifically, the learning processing part 38 acquires the network name of the IP address of the destination host 14 by transmitting to the holder information server 22 the FQDN of the destination host 14 included in the communication log 16a as a query and then includes the network name in the learning data. If an unscrupulous person applies for multiple IP addresses to a regional Internet registry, the same network name is assigned to the multiple IP addresses. The multiple destination hosts 14 indicated by the multiple IP addresses with the same network name may be managed and used by the unscrupulous person for any threatening purposes. The learner 34 may thus predict the presence or absence of the threat of the destination host 14 in accordance with the network name of the IP address of the destination host 14. Specifically, the learner 34 may predict more accurately the possibility of the threat of a destination host 14 indicated by an IP address having the same network name as the IP address of the destination host 14 that has been determined to be threatening.

The learning processing part 38 performs a pre-process on the learning data before inputting the learning data to the learner 34. In the pre-process, the learning processing part 38 performs a dictionary-entry process to convert the learning data into a dictionary. Since the learner 34 is able to recognize only numerical values as the learning data, the learning processing part 38 converts the learning data expressed in characters into numerical values (the dictionary-entry process). In the IP addresses of the destination host 14 and the name server 20, each octet may include multiple numerical values (for example, “101.xxx. . . . ”). Each numerical value of the octet, such as “1,” “0,” and “1” does not have any meaning but a group of numerical values in each octet, such as “101,” has a meaning. In the dictionary-entry process, the multiple numerical values in an octet are considered as a whole and the whole numerical value (such as “101”) is converted into a single value.

In the FQDN dictionary-entry process, a specific character string included in the FQDN is converted into a numerical value. The specific character may be converted into a numerical value that is different from when the specific character is at a particular location to when the specific character is not at the particular location. For example, a character string “.com” attached to the end of FQDN means a domain for commercial organization and a character sting “.com” at another location (for example, in the middle of the FQDN) has a different meaning. The learning processing part 38 thus converts the character string “.com” attached to the end of the FQDN and the character sting “.com” at another location to correspondingly different numerical values and inputs the different numerical values to the learner 34. The learning processing part 38 thus causes the learner 34 to learn the difference in meaning.

The octet of each IP address is typically expressed in decimal. In the pre-process, the learning processing part 38 may covert the octet into N-ary notation (N is any number). The learning processing part 38 converts a portion representing a host of each IP address (host address in IPv4) to the N-ary notation. According to the exemplary embodiment, the learning processing part 38 converts the portion representing the host of each IP address into an octal notation. For example, a host address “104 (in decimal)” of the IP address of the destination host 14 is converted into an octal notation “150” and a host address “105 (in decimal)” of the IP address of the destination host 14 is converted into an octal notation “151.”

The learning processing part 38 divides the octet in the N-ary notation into multiple portions and converts the portions into numerical values in the dictionary-entry process. According to the exemplary embodiment, the quotient and the remainder resulting from dividing the octet in the octal notation by 10 are converted into respective numerical values. This means that the octet in the octal notation is divided into the last digit of the octet and the higher digits and the last digit and the higher digits are converted into numerical values. For example, “150” and “151” in the octal notation may now be considered. The lower digit numbers “0” and “1” are respectively converted into “1” and “2”, and the higher digit numbers “15” are converted into “3.” “150” in the octal notation is converted into “31” and “151” in the octal notation is converted into “32.”

If two host addresses “104” and “105” in decimal are quantified, the closeness in address is difficult to express in numerical value. According to the exemplary embodiment, the octet in the N-ary notation is divided into multiple portions and each portion is then quantified. The numerical values after the conversion thus express the closeness (similarity) in IP address. Specifically, the common portion in the octal notation (namely “15”) is converted into the same value. Based on the common portion, the learner 34 learns the similarity of the two IP addresses. The IP addresses of the destination hosts 14 expressing the similarity are input to the learner 34. The learner 34 may thus learn accounting for the IP addresses that are similar to each other.

In the pre-process, the learning processing part 38 excludes from the learning data a specific character string included in the FQDN. For example, the specific character sting “www” of the FQDN is included in the FQDN of many destination hosts 14 regardless of the presence or absence of a threat. Considering such a character string in the learning process may not contribute to the learning process itself but rather reduce the learning efficiency of the learning process. In the pre-process, a special character string, such as “www,” is thus excluded from the learning data. The domain name to be input to the learner 34 may be part of the FQDN rather than the whole FQDN.

The learning processing part 38 thus causes the learner 34 to perform the learning process using the learning data described above. The learning processing part 38 may cause the learner 34 to learn accounting for the location of a label (character string at the location divided at a period “.”) of the FQDN of the destination host 14 and at least one of other labels prior to or subsequent to the location of the label.

Specifically, the learning processing part 38 provides to the learner 34 a combination of the label and the specific location in the FQDN as a condition during the learning process. According to the exemplary embodiment, the learning processing part 38 further provides to the learner 34 a combination of the specific location in the FQDN and the other labels prior to and subsequent to the label as a condition.

For example, the condition is defined as follows: the label is “fujixerox,” the specific locations are “a location at the second position from the left and a location at the third position from the right”, a label prior to the label is “www,” and a label subsequent to the label is “co.” FQDN www.fujixerox.co.jp” may now be input as the learning data together with threat-free teacher data to the learner 34. In such a case, the FQDN satisfies the above condition and the FQDN is free from any threat. If the above condition is satisfied, the learner 34 may learn that the possibility of no threat is higher. On the other hand, the condition may not be satisfied and the FQDN www.fujixerox.net.xxx.yyy.org” may be input as the learning data together with the teacher data with threat to the learner 34. In such a case, the FQDN fails to satisfy the condition and gives a threat. If the condition is not satisfied, the learner 34 may learn that the possibility of the presence of a thread is higher.

The learning processing part 38 causes the learner 34 to learn accounting for the location of the label in the FQDN of the destination host 14 and at least one of the other labels prior to or subsequent to the label. To this end, the learning processing part 38 may convert the same label into different numerical values in the dictionary-entry process depending on the location of the label in the FQDN of the destination host 14 and at least one of the other labels prior to or subsequent to the label. For example, “fujixerox” in the FQDN www.fujixerox.co.jp and “fujixerox” in the FQDN www.fujixerox.net.xxx.yyy.org may be converted to mutually different numerical values.

The label “fujixerox” has been considered. The learning processing part 38 may provide to the learner 34 a condition related to another label (such as “www,” “co,” or “jp”).

When the learner 34 has sufficiently learned, the security server 24 is ready to determine the presence or absence of a threat of an unknown destination host 14.

When the originating terminal 12 starts communication with a new destination host 14, the URL of the destination host 14 is transmitted from the originating terminal 12 to the network device 16. The destination host 14 may or may not be a host which the originating terminal 12 has not accessed before. In accordance with the URL, the network device 16 acquires the new domain name and IP address of the destination host 14 and the information indicating the name server 20 managing the new domain name in the process described above and transmits these pieces of information to the security server 24.

Before the network device 16 accesses the destination host 14, the destination determination part 40 in the security server 24 inputs to the learner 34 the new domain name and IP address of the destination host 14 and the information indicating the name server 20 managing the new domain name received from the network device 16. In response to the output from the learner 34, the destination determination part 40 determines the presence or absence of a threat of the destination host 14. In a way similar to the process of the learning processing part 38, the destination determination part 40 performs the dictionary-entry process on the input data described above and then inputs the processed data to the learner 34.

If the learner 34 has learned using the learning data including the holder country of the IP address of the destination host 14, the destination determination part 40 inputs to the learner the learner 34 the information indicating the holder country of the new IP address acquired from the holder information server 22. If the learner 34 has learned using the learning data including the network name of the IP address of the destination host 14, the destination determination part 40 further inputs to the learner 34 the network name of the new IP address acquired from the holder information server 22.

The IP address of the destination host 14 may be expressed in the N-ary notation, the octet in the N-ary notation is divided into multiple portions, and the portions are converted into numerical values. If the learner 34 has learned using the learning data including the IP address of the destination host 14 with the converted numerical values, the destination determination part 40 expresses a new IP address acquired from the holder information server 22 in the N-ary notation, divides an octet in the N-ary notation into multiple portions, and converts (dictionary-entry processes) each portion into a numerical value to obtain a new IP address. The destination determination part 40 then inputs the resulting new IP address to the learner 34.

The presence or absence of a threat of an unknown destination host 14 may also be determined using the learned learner 34. By selecting the learning data in the learning process of the learner 34, performing the pre-process on the learning data, or attaching the condition during the learning process as described above, the determination accuracy of the learner 34 may be increased. According to the exemplary embodiment, the presence or absence of the threat of the unknown destination host 14 may be determined at a higher accuracy level.

Upon determining that the destination host 14 does not give any threat, the destination determination part 40 authorize the access to the destination host 14, namely, permits the originating terminal 12 to communicate with the destination host 14. On the other hand, upon determining that the destination host 14 may possibly give a threat, the destination determination part 40 prohibits the network device 16 from accessing the destination host 14, namely, blocks the communication between the originating terminal 12 and the destination host 14.

If the destination determination part 40 determines that the destination host 14 may possibly give a threat, the notification processing part 42 notifies the originating terminal 12 via the network device 16 that the communication with the destination host 14 is prohibited, namely, the destination host 14 may possibly give a threat.

According to the exemplary embodiment, the learning processing part 38 performs the learning process by causing the learner 34 to learn. The learner 34 may learn with another device and the learned learner 34 may be stored on the memory 32.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to,
input a new domain name, a new Internet protocol (IP) address, and information indicating a name server managing the new domain name to a learner to determine presence or absence of a threat of a new destination host indicated by the new domain name and the new IP address, wherein, by using learning data including a domain name and an IP address indicating a destination host, information indicating a name server managing the domain name, and information on presence or absence of a threat of the destination host, the learner has learned to output the information on the presence or the absence of the threat of the destination host indicated by the domain name and the IP address in response to an input of the domain name, the IP address, and the information indicating the name server managing the domain name.

2. The information processing apparatus according to claim 1, wherein the learner has learned by using the learning data including information indicating a holder country of the IP address of the destination host, and
wherein the processor is configured to input, to the learner, information indicating a holder country of the new IP address.

3. The information processing apparatus according to claim 1, wherein the learner has learned by using the learning data including a network name of the IP address of the destination host, and
wherein the processor is configured to input to the learner a network name of the new IP address.

4. The information processing apparatus according to claim 2, wherein the learner has learned by using the learning data including a network name of the IP address of the destination host, and
wherein the processor is configured to input to the learner a network name of the new IP address.

5. The information processing apparatus according to claim 1, wherein the learner has learned by using the learning data including a dictionary-entry processed IP address of the destination host that results from converting a part of the IP address of the destination host indicating the destination host to the part of the IP address in an N-ary notation (N is any number), dividing the part of the IP address in the N-ary notation into a plurality of portions, and dictionary-entry processing the plurality of portions into the dictionary-entry processed IP address, and
wherein the processor is configured to convert a part of the new IP address representing a host to the part of the new IP address in the N-ary notation, divide the part of the new IP address in the N-ary notation into a plurality of portions, dictionary-entry process the plurality of portions of the part of the new IP address into a dictionary-entry processed new IP address, and input the dictionary-entry processed new IP address to the learned learner.

6. The information processing apparatus according to claim 2, wherein the learner has learned by using the learning data including a dictionary-entry processed IP address of the destination host that results from converting a part of the IP address of the destination host indicating the destination host to the part of the IP address in an N-ary notation (N is any number), dividing the part of the IP address in the N-ary notation into a plurality of portions, and dictionary-entry processing the plurality of portions into the dictionary-entry processed IP address, and
wherein the processor is configured to convert a part of the new IP address representing a host to the part of the new IP address in the N-ary notation, divide the part of the new IP address in the N-ary notation into a plurality of portions, dictionary-entry process the plurality of portions of the part of the new IP address into a dictionary-entry processed new IP address, and input the dictionary-entry processed new IP address to the learned learner.

7. The information processing apparatus according to claim 3, wherein the learner has learned by using the learning data including a dictionary-entry processed IP address of the destination host that results from converting a part of the IP address of the destination host indicating the destination host to the part of the IP address in an N-ary notation (N is any number), dividing the part of the IP address in the N-ary notation into a plurality of portions, and dictionary-entry processing the plurality of portions into the dictionary-entry processed IP address, and
wherein the processor is configured to convert a part of the new IP address representing a host to the part of the new IP address in the N-ary notation, divide the part of the new IP address in the N-ary notation into a plurality of portions, dictionary-entry process the plurality of portions of the part of the new IP address into a dictionary-entry processed new IP address, and input the dictionary-entry processed new IP address to the learned learner.

8. The information processing apparatus according to claim 4, wherein the learner has learned by using the learning data including a dictionary-entry processed IP address of the destination host that results from converting a part of the IP address of the destination host indicating the destination host to the part of the IP address in an N-ary notation (N is any number), dividing the part of the IP address in the N-ary notation into a plurality of portions, and dictionary-entry processing the plurality of portions into the dictionary-entry processed IP address, and
wherein the processor is configured to convert a part of the new IP address representing a host to the part of the new IP address in the N-ary notation, divide the part of the new IP address in the N-ary notation into a plurality of portions, dictionary-entry process the plurality of portions of the part of the new IP address into a dictionary-entry processed new IP address, and input the dictionary-entry processed new IP address to the learned learner.

9. An information processing apparatus comprising a processor configured to,
input a new domain name to a learner to determine presence or absence of a threat of a new destination host indicated by the new domain name, wherein, by using learning data including a domain name indicating a destination host and information on presence or absence of a threat of the destination host, a learner has learned to output the information on the presence or the absence of the destination host indicated by the domain name in response to an input of the domain name in consideration of a location of a first label of the domain name and at least one of second labels located subsequent to or prior to the first label.

10. A non-transitory computer readable medium storing a program causing a computer to execute a process for processing information, the process comprising:
inputting a new domain name, a new Internet protocol (IP) address, and information indicating a name server managing the new domain name to a learner to determine presence or absence of a threat of a new destination host indicated by the new domain name and the new IP address, wherein, by using learning data including a domain name and an IP address indicating a destination host, information indicating a name server managing the domain name, and information on presence or absence of a threat of the destination host, the learner has learned to output the information on the presence or the absence of the threat of the destination host indicated by the domain name and the IP address in response to an input of the domain name, the IP address and the information indicating the name server managing the domain name.
